(19) United States
(12) Patent Application Publication
(10) Pub. No.: US 2006/0263766 A1
(43) Pub. Date: Nov. 23, 2006

(54) Compositions and chromatography materials for bioseparation

(76) Inventors: Agathagelos Kyrlidis, Malden, MA (US); Arijit Bose, Lexington, MA (US); Feng Gu, Westford, MA (US)

Correspondence Address: KILYK & BOWERSOX, P.L.L.C., 400 HOLIDAY COURT, SUITE 102, WARRENTON, VA, 20186, US

(21) Appl. No.: 11/362,274

(22) Filed: Feb. 24, 2006

Related U.S. Application Data
(63) Continuation of application No. PCT/US04/27431, filed on Aug. 24, 2004.
(60) Provisional application No. 60/497,670, filed on Aug. 25, 2003.
(60) Provisional application No. 60/500,076, filed on Sep. 4, 2003.

(51) Int. Cl. C12Q 1/70; C12N 7/02

(52) U.S. Cl. 435/5; 435/239

(57) ABSTRACT

The present invention relates to compositions and chromatography materials, such as materials for the separation of biomolecules. The composition can comprise granules comprising carbonaceous particles, and at least one carbonized substance selected from carbonized synthetic resins and carbonized pitches. The composition further comprises at least one organic group attached to the surface of the granules. Biomolecules to be separated can include proteins, viruses, and DNA plasmids. The composition can have granule sizes, particle sizes, and pore sizes designed for separation of a particular biomolecule depending on its size or binding properties.

This application is a continuation of International Patent Application No. PCT/US2004/027431 filed Aug. 24, 2004, which in turn claims the benefit under 35 U.S.C. §119(e) of prior U.S. Provisional Patent Application No. 60/497,670 filed Aug. 25, 2003 and U.S. Provisional Patent Application No. 60/500,076 filed Sep. 4, 2003, which are incorporated in their entireties by reference herein.

### FIELD OF THE INVENTION

The present invention relates to new chromatographic materials. These materials can be applied to bioseparations, such as separation of viruses, proteins, and other biological molecules.

### BACKGROUND OF THE INVENTION

The present invention generally relates to a composition comprising granules. The granules comprise carbonaceous particles and at least one carbonized substance selected from carbonized synthetic resins and carbonized pitches, for binding the carbonaceous particles together. The composition further comprises at least one organic group attached to the surface of the granules.

Conventional packing materials for liquid chromatography have included silica gel materials, synthetic resin-based materials, cellulose, and agarose based materials. However, problems such as chemical stability, including solubility, have resulted in silica gel-based materials exhibiting poor durability as a packing material. No single current medium provides all of the properties desirable for separation media. For example agarose based particles are highly biocompatible, do not have non-specific binding and have large pores. However, they are compressible, limiting both the bed height and the flow rates that can be used. Synthetic polymer based particles are less biocompatible, sometimes degrade during regeneration at high pH, and often do not have the range of pore sizes that are suitable, resulting in reduced yield.

In chromatography and other separation methods, it is often ideal to achieve sufficient selectivity for the stationary phase to separate the various components in a mixture. For this reason, carbon products, such as carbon black, have not been used as a standard stationary phase in separation systems because carbon is a strong non-specific adsorbent. Carbon products, however, would have many advantages over commercially available adsorbents. For instance, there are minimal corrosion problems and/or swelling problems with carbon products. In addition, carbon products can be subjected to large temperature ranges, pH ranges, and/or extreme pressures which would be beneficial for certain types of adsorptions, such as temperature swings used in some types of chromatography. For example, with certain separation processes used in the production of biopharmaceuticals for clinical applications, the sterilization requirements or recommendations provide for the use of hot sodium hydroxide. The current conventional separation devices, such as conventional silica columns, are often inadequate under such conditions. Further, many polymeric columns such as cellulose polymers, are chemically but not physically stable to such sterilization treatments.

In one example, there remains a need for new chromatography materials for the separation of viruses. Recombinant viruses are candidates for delivery of therapeutic genes into target cells by specific target recognition, then use of a host cell to incorporate missing genes into host DNA. Single gene therapy accounted for 8.8% of patients undergoing treatment using viral vectors in the year 2002. Other developments include viral vaccines and viral clearance during protein manufacture.

Based on ongoing technology, the demand for viral vectors may rise significantly. Oncolytic viruses specifically replicate within and then lyse cancer cells (for example, by taking advantage of the abnormal functioning of tumor suppressor gene/s), while not replicating in normal cells. Oncolytic viruses have been used in end-stage cancer therapy, and accounted for 68.4% of patients undergoing viral vector based treatment in 2002. For 2002, viral vector based therapy was used in 610 clinical trials (mostly phase I and phase II) worldwide, treating 3500 patients. Of these, approximately 50% used retroviruses (RV), 18% used adenoviruses (AV), and 1% used adenoassociated viruses (AAV). The remaining was non-viral vectors. Approximately 2×10¹⁶ viral particles were required for all of the clinical trials in 2002.

Recombinant vectors are typically produced in cell culture media. Their application for therapy often requires a high degree of purification. The isolation of a high titer of viruses typically involves several steps, beginning with removal of cell debris by filtration, solution concentration using tangential flow microfiltration, and a final polishing step to separate proteins from the target viruses. Current techniques for virus purification/polishing include cesium chloride density gradient centrifugation and size exclusion chromatography (SEC). The former technique is not easily scaleable, as it requires removal of cesium chloride, and takes approximately 24 hours to complete. SEC processes often induce damage to the virus because of shear. Adenoviruses have fibers extending from the capsids (proteins on the fiber give the virus the ability to recognize and insert themselves into host cells), which are extremely shear sensitive. The loss of even a small fraction may impact the virus infectivity.

The use of chromatographic materials for protein separation may not be easily extended for use as viral separation media. Protein separation media contain pores that have diameters that are approximately ten times the protein size, i.e., of the order of ˜100 nm. Viruses are approximately an order of magnitude larger than proteins, and often plug the pores in protein separation media, leading to low yield during separation.

Accordingly, there remains a need for new chromatography materials useful in various chromatographic applications.

### SUMMARY OF THE INVENTION

One aspect of the present invention provides a composition comprising:

granules comprising:
carbonaceous particles; and
at least one carbonized substance selected from carbonized synthetic resins and carbonized pitches; and

at least one organic group attached to the surface of the granules;

wherein the granules have a mean diameter ranging from about 15 μm to about 200 μm and a mean pore size of less than about 500 nm.

Another aspect of the present invention provides a chromatographic material for the separation of a virus, comprising:

granules comprising:
carbonaceous particles; and
at least one carbonized substance selected from carbonized synthetic resins and carbonized pitches; and

at least one organic group attached to the surface of the granules;

wherein the granules have a mean diameter ranging from about 15 μm to about 200 μm and a mean pore size of at least about five times the mean size of the virus, protein, or any other biological molecule to be separated.

Another aspect of the present invention provides a composition comprising:

granules comprising:
carbonaceous particles; and
at least one carbonized substance selected from carbonized synthetic resins and carbonized pitches; and

at least one organic group attached to the surface of the granules;

wherein the granules have a mean diameter ranging from about 15 μm to about 200 μm and a mean pore size of from about 100 nm to about 10 μm.

Another aspect of the present invention provides a method of chromatographic separation comprising:

(a) providing a chromatography column containing a composition comprising:
(i) granules comprising:
   carbonaceous particles; and
   at least one carbonized substance selected from carbonized synthetic resins and carbonized pitches; and
(ii) at least one organic group attached to the surface of the granules;
wherein the granules have a mean diameter ranging from about 15 μm to about 200 μm and a mean pore size of less than about 500 nm such as less than 100 nm; and

(b) providing a sample containing at least one biomolecule; and

(c) passing the at least one biomolecule through the column.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 is a plot of % retention (y-axis) versus particle size in microns (x-axis), showing the particle size distribution for granules A and B;

FIG. 2 is an SEM image of granules A after spray drying with the phenolic resin, shown at 200× magnification; and

FIG. 3 is an SEM image of granules B after spray drying with the phenolic resin, shown at 200× magnification.

FIG. 4 is a graph plotting capacity in mg/ml packed bed (y-axis) or yield % (y-axis) versus flow rate in cm/hr for granules of the present invention.

### DESCRIPTION OF THE EMBODIMENTS

The present invention relates, generally, to a composition comprising granules and at least one organic group attached to the surface of the granules. The composition can be used as a chromatography material, such as a column packing chromatography material. The methods, organic groups, and other components of the granule as described in WO 03/020639 can be used herein with the modification described below, and this publication is incorporated in its entirety by reference herein.

In one embodiment, the granules comprise carbonaceous particles and at least one carbonized substance. In one embodiment, the composition can comprise one granule. In one embodiment, the granule can comprise from 5 to 20 or more carbonaceous particles, on average. In one embodiment, the at least one carbonized substance is one or more types of carbonized synthetic resins and/or carbonized pitches, for binding the carbonaceous particles together. In one embodiment, in the preparation of the granules, the carbonaceous particles can be mixed with the synthetic resin and/or pitch, which can be carbonized upon heating.

The composition can be used for any number of chromatographic applications. The properties of the granules can be modified by modifying the surface of the granules. In one embodiment, at least one organic group is attached to the surface of the granules. As used herein, “at least one organic group attached to the surface of the granules,” refers to adsorbing, coating, covalently bonding, ionically bonding, or any noncovalent interaction between the at least one organic group and the surface. The at least one organic group can at least partially cover the surface, for example, fully covering or partially covering the surface, whether it be intermittent, discontinuous, patterned, or comprise a plurality of individual compounds dotting the surface.

In one embodiment, the composition can be used as a chromatography material for the separation of biomolecules. Exemplary biomolecules to be separated include proteins, viruses, and DNA plasmids. In one embodiment, the chromatography material can be used as for anion exchange chromatography, cation exchange chromatography, or affinity chromatography.

In one embodiment, the granules are porous. The porosity can have the effect of increasing surface area, and thus increasing the capacity of the bioseparation per amount of material. The pore size can be tailored depending on the biomolecule to be separated. For example, in one embodiment, it is desired to avoid pores having substantially the same size as the biomolecule, as similar sized biomolecules can clog the pores and cause loss of yield and/or increase in pressure drop. Accordingly, in one embodiment, the composition comprises granules having a mean pore size less than the size of the biomolecule, such as a mean pore size less than half the size of the biomolecule, or less than ⅕ the size of the biomolecule. In another embodiment, the composition comprises granules having a mean pore size greater than the size of the biomolecule, such as a mean pore size greater than twice the size of the biomolecule, greater than five times the size of the biomolecule, or even greater than ten times the size of the biomolecule.

In one embodiment, the granules are non-porous.

In one embodiment, the granules have a mean pore size less than about 500 nm, such as a mean pore size of less than 300 nm, or less than 100 nm, or less than about 50 nm or a mean pore size less than about 20 nm. For example, the mean pore size can be from 0.5 nm to less than 500 nm. Compositions comprising such granules can be used, for example, for the separation of viruses.

In one embodiment, the composition is used for viral separation and comprises granules having a mean pore size greater than twice the size of the virus, such as a mean pore size greater than five times the size of the virus or even greater than ten times the size of the virus. For example, viruses can have sizes ranging from 25 nm to 300 nm, with a typical size of the order of about 100 nm.

Preparative scale chromatography is commonly used in the final purification stages for therapeutic recombinant virus produced in cell culture. Chromatographic media particles are typically made porous. The resulting pore surfaces can provide additional active surface area. In one embodiment, the granules have pore sizes of at least about 0.1 μm, such as a pore size of at least about 0.5 μm, or at least about 1 μm. Carbonaceous materials having larger pore sizes include those described in U.S. Pat. Nos. 5,053,135, 5,393,430, and 5,609,763, the disclosures of which are incorporated by reference herein.

Other embodiments of the compositions are described below.

Carbonaceous Particles and Granules

Exemplary carbonaceous particles include those selected from graphite powder, graphite fibers, carbon fibers, carbon cloth, vitreous carbon products, activated carbon products, and carbon black. In one embodiment, the carbonaceous particulate material is carbon black. Other exemplary carbonaceous particles can include, but are not limited to, carbon aerogels, pyrolized ion exchange resins, pyrolized polymer resins, meso carbon microbeads, pelleted carbon powder, nanotubes, bucky balls, silicon-treated carbon black, silica-coated carbon black, metal-treated carbon black, densified carbon black, activated carbon or other carbonaceous material obtained by the pyrolysis of cellulosic, fuel oil, polymeric, or other precursors and combinations thereof or activated versions thereof. The carbonaceous particles can also include, but are not limited to, material obtained by the compaction of small carbon particles and other finely divided forms of carbon as long as the carbonaceous particles have the ability to adsorb at least one adsorbate and may be capable of being chemically modified in accordance with the present invention. The carbonaceous particles can also be a waste product or by-product of carbonaceous material obtained by pyrolysis.

In one embodiment, the granules have a mean diameter ranging from about 15 μm to about 200 μm, such as mean diameters ranging from about 15 μm to about 100 μm, from about 15 μm to about 50 μm, or from about 30 μm to about 100 μm.

The granules can have a variety of size distributions. For instance, the granules of the present invention can have a size distribution of a full width at half maximum ranging from about 10% to about 50% of the mean. As another example, the granules can have a size distribution of a full width at half maximum ranging from about 10% to about 30% of the mean or a size distribution of a full width at half maximum ranging from about 10% to about 20% of the mean. Furthermore, the granules of the present invention can have a pore size distribution with pores ranging from about 15 nm to about 200 nm or more.

In one embodiment, the carbonaceous particles have a mean diameter ranging from about 12 nm to about 150 nm prior to granulation, for example, from about 12 to about 30 nm, and a specific surface area of from about 50 to about 550 m²/g, for example, from about 80 to about 250 m²/g. In one embodiment, the carbonaceous particles have a dibutyl phthalate (DBP) oil adsorption ranging from about 50 to about 200 mL/100 g, for example, from about 80 to about 150 mL 100 g.

In one embodiment, the carbonaceous particles can be an aggregate having at least one carbon phase and at least one silicon-containing species phase. The aggregate can be one or more of the aggregates described in U.S. Pat. Nos. 6,008,271; 5,977,213; 5,948,835; 5,919,841; 5,904,762; 5,877,238; 5,869,550; 5,863,323; 5,830,930; 5,749,950; 5,622,557; and 5,747,562. Furthermore, the aggregates described in WO 98/47971; WO 96/37547; and WO 98/13418 can also be used, and each of these patents and publications is incorporated herein in its entirety by reference.

In one embodiment, after use as a chromatography material, the granules can be regenerated over multiple cycles, for instance, using a high pH buffer or other regeneration techniques.

In another embodiment, the carbonaceous particles can be a carbon black which is at least partially coated with silica. Examples of such an aggregate are described in U.S. Pat. No. 5,916,934 and WO 98/13428 which are incorporated herein in their entireties by reference.

Besides the above-described aggregates, the carbonaceous particles can also be an aggregate having at least a carbon phase and a metal-containing species phase as described in PCT Publication WO 98/47971 which is incorporated herein in its entirety by reference.

In addition, the aggregates and methods of making multi-phase aggregates from U.S. Pat. Nos. 6,211,279; and 6,057,387; and U.S. patent application Ser. No. 09/453,419 can be used, and all of these patents and application are incorporated herein in their entireties by reference. Additionally, the aggregates of U.S. Patent Application No. 60/163,716 having attached polymer groups can be used as can the modified pigments described in U.S. Patent Application No. 60/178,257, both of which applications are also incorporated herein in their entireties by reference.

In one embodiment, the carbonaceous particles are activated carbon or carbon black capable of adsorbing an adsorbate. Commercial examples of carbon black include, but are not limited to, Black Pearls® 2000 carbon black, Black Pearls® 430 carbon black, Black Pearls® 700 carbon black, Black Pearls® 900 carbon black, Black Pearls® 130 carbon black, and Black Pearls® 120 carbon black, all available from Cabot Corporation. Commercial examples of activated carbon include Darco S51, available from Norit; Sorbonorit 3, available from Norit; and BPL activated carbon from Calgon. The carbonaceous particles modified by the procedures described herein may be a microporous or mesoporous activated carbon in granular or pellet form; a carbon black of different structures in fluffy or pelleted form; or any other carbonaceous particles whose applicability to this invention is apparent to those skilled in the art, such as carbon fibers or carbon cloth. The choice of carbonaceous particles used eventually depends on a variety of different factors, including the application for which it is intended. Preferably, each of these types of carbonaceous particles has the ability to adsorb at least one adsorbate. A variety of BET surface areas, micropore volumes, and total pore volumes are available depending on the desired end use of the carbonaceous material.

In one embodiment, the granules obtained are composite bodies containing the carbonaceous particles and an agent that upon carbonization aids in forming a granule of high crush strength. The agent can act as a binder and can include the carbonized product of a synthetic resin, pitch component, or synthetic resin/pitch component mixture.

In one embodiment, the granules have an aspect ratio (e.g., Lₘᵢₙ/Lₘₐₓ) ratio ranging from about 0.75 to about 1.25, for example, a ratio ranging from about 0.90 to about 1.0. In one embodiment, the Lₘᵢₙ/Lₘₐₓ ratio ranges from about 0.95 to about 1.0. The granules can have a particle diameter ranging from about 1 to about 200 μm.

In one embodiment, the granules have a highly porous surface. For example, the granules can have specific surface area ranging from about 10 to about 650 m²/g, such as a surface area ranging from about 15 to about 550 m²/g. In one embodiment, the granules have a total micropore volume ranging from about 0.01 to about 2.0 mL/g, such as a micropore volume ranging from about 0.3 to about 2.0 mL/g. In one embodiment, the granules have a V_{0.5}/V_{1.0} ratio of about 0.4 or smaller, such as a ratio of about 0.2 or smaller, wherein V_{0.5} is the gas adsorption volume at a relative pressure P/P₀ of 0.5 and V_{1.0} is the nitrogen gas adsorption volume at a relative pressure P/P₀ of about 1.0 at nitrogen gas adsorption isotherm.

Carbonized Substance

In one embodiment, the at least one carbonized substance acts to bind the carbonaceous particles. The synthetic resin and/or pitch can be carbonized by heating.

Exemplary synthetic resins that can be used according to the present invention include phenolic resins, furan resins, furfural resins, divinyl benzene resins, urea resins, and mixtures thereof.

In one embodiment, the carbonized pitch is toluene-soluble or benzene-soluble. The pitch can be a component of petroleum pitches, coal-tar pitches, or liquefied oil from coal.

The synthetic resin and pitch can be used together, for example, whereby the pitch is combined with the synthetic resin before contacting the carbonaceous particles. The synthetic resin and pitch mixture can be used, for example, in an amount of from about 5 parts by weight to about 500 parts by weight, for example, from about 40 parts by weight to about 300 parts be weight, per 100 parts by weight of carbonaceous particles.

Organic Group

In one embodiment, once the desired separation technique is chosen and one or more of the particular species to be separated is selected, a particular functional group or multiple functional groups can be chosen to be attached onto the carbonaceous material or granule in order to accomplish the selectivity needed to conduct the separation process.

In one embodiment, the at least one organic group is a functional group selected to interact with a biomolecule. The functional group comprises a group that can be selected from:

polyethylene glycol, methoxy-terminated polyethylene glycol, resins derivatized with polyethylene glycol, or resins derivatized with methoxy-terminated polyethylene glycol;

—Ar—(CH₂)ₘ(O(CH₂)_{y})ₙNR₂ or —Ar—(CH₂)ₘ(O(CH₂)_{y})ₙN⁺R₃, wherein m and y are independently chosen from an integer ranging from zero to 6; n ranges from 1 to 30; and R is chosen from hydrogen and/or alkyls (e.g., substituted or unsubstituted), such as C₁₋₂₀ like methyl and ethyl;

—Ar—C(O)(O(CH₂)_{y})ₙNR₂ or —Ar—C(O)(O(CH₂)_{y})ₙN⁺R₃, wherein y is an integer ranging from zero to 6; n ranges from 1 to 30; and R is chosen from hydrogen and/or alkyls (e.g., substituted or unsubstituted), such as C₁₋₂₀ like methyl and ethyl;

—Ar—C(O)NH(CH₂)ₘ(O(CH₂)_{y})ₙNR₂ or —Ar—C(O)NH(CH₂)ₘ(O(CH₂)_{y})ₙN⁺R₃, wherein m and y are independently chosen from an integer ranging from zero to 6; n ranges from 1 to 30; and R is chosen from hydrogen and/or alkyls (e.g., substituted or unsubstituted), such as C₁₋₂₀ like methyl and ethyl;

—Ar—(CH₂)ₘ(O(CH₂)_{y})ₙCOOH, wherein m and y are independently chosen from an integer ranging from zero to 6; n ranges from 1 to 30;

—Ar—(CH₂)ₘ(O(CH₂)_{y})ₙSO₃H, wherein m and y are independently chosen from an integer ranging from zero to 6; n ranges from 1 to 30;

—Ar—((CₙH₂ₙ)COOX)ₘ, wherein n ranges from 0 to 20, m ranges from 1 to 3, and X is chosen from hydrogen, cations, such as metal cations, quaternary ammonium groups, or an organic group capable of bonding to a carboxylate;

—Ar—((CₙH2n)OH)ₘ, wherein n ranges from 0 to 20, and m ranges from 1 to 3;

—Ar—((CₙH₂ₙ)NR₂)ₘ, wherein n ranges from 0 to 20, m ranges from 1 to 3, and R is chosen from hydrogen and/or alkyls (e.g., substituted or unsubstituted), such as C₁₋₂₀ like methyl and ethyl;

—Ar—((CₙH2n)NR₃X)ₘ, wherein n ranges from 0 to 20, m ranges from 1 to 3, X is an anion, and R is chosen from hydrogen and/or alkyls (e.g., substituted or unsubstituted), such as C₁₋₂₀ like methyl and ethyl;

—Ar—R wherein R is an ionic or ionizable group; or

a ligand, for binding a target.

In each of the above formula and elsewhere throughout the present application, Ar is an aromatic group, such as heteroaromatic group, phenyl, naphthyl, benzothiazolyl, benzothiadiazolyl, or the like. Also, each R can be the same or different.

In another embodiment, the present invention relates to treating agents that can be used in the present application. These treating agents can be used in methods to attach organic groups onto the granules and/or onto the carbonaceous parts of the granule. The treating agents are:

H₂N—Ar—(CH₂)ₘ(O(CH₂)_{y})ₙNR₂ or H₂N—Ar—(CH₂)ₘ(O(CH₂)_{y})ₙN⁺R₃, wherein m and y are independently chosen from an integer ranging from zero to 6; n ranges from 1 to 30; and R is chosen from hydrogen and/or alkyls (e.g., substituted or unsubstituted), such as C₁₋₂₀ like methyl and ethyl;

H₂N—Ar—C(O)(O(CH₂)_{y})ₙNR₂ or H₂N—Ar—C(O)(O(CH₂)_{y})ₙN⁺R₃, wherein y is an integer ranging from zero to 6; n ranges from 1 to 30; and R is chosen from hydrogen and/or alkyls (e.g., substituted or unsubstituted), such as C₁₋₂₀ like methyl and ethyl;

H₂N—Ar—C(O)NH(CH₂)ₘ(O(CH₂)_{y})ₙNR₂ or H₂N—Ar—C(O)NH(CH₂)ₘ(O(CH₂)_{y})ₙN⁺R₃, wherein m and y are independently chosen from an integer ranging from zero to 6; n ranges from 1 to 30; and R is chosen from hydrogen and/or alkyls (e.g., substituted or unsubstituted), such as C₁₋₂₀ like methyl and ethyl;

H₂N—Ar—(CH₂)ₘ(O(CH₂)_{y})ₙCOOH, wherein m and y are independently chosen from an integer ranging from zero to 6; n ranges from 1 to 30;

H₂N—Ar—(CH₂)ₘ(O(CH₂)_{y})ₙSO₃H, wherein m and y are independently chosen from an integer ranging from zero to 6; n ranges from 1 to 30;

H₂N—Ar—((CₙH₂ₙ)COOX)ₘ, wherein n ranges from 0 to 20, m ranges from 1 to 3, and X is chosen from hydrogen, cations, such as metal cations, quaternary ammonium groups, or an organic group capable of bonding to a carboxylate;

H₂N—Ar—((CₙH₂ₙ)OH)ₘ, wherein n ranges from 0 to 20, and m ranges from 1 to 3;

H₂N—Ar—((CₙH₂ₙ)NR₂)ₘ, wherein n ranges from 0 to 20, m ranges from 1 to 3, and R is chosen from hydrogen and/or alkyls (e.g, substituted or unsubstituted), such as C₁₋₂₀ like methyl and ethyl;

H₂N—Ar—((CₙH₂ₙ)NR₃X)ₘ, wherein n ranges from 0 to 20, m ranges from 1 to 3, X is an anion, and R is chosen from hydrogen and/or alkyls (e.g., substituted or unsubstituted), such as C₁₋₂₀ like methyl and ethyl; or

H₂N—Ar—R wherein R is an ionic or ionizable group. Ar is the same as above. Each R in the above formulas can be the same or different. In lieu of the —NH₂ ending, other terminal groups can be present.

In one embodiment, the at least one organic group is a passivating group that substantially resists the adsorption of biomolecules. Such groups minimize non-specific binding of the biomolecules. In one embodiment, the passivating group terminates with a structure selected from the formula —[(CH₂)ₙO]ₘ(CH₂)ₙOR, wherein n is an integer ranging from 1-6, m is an integer ranging from 0-100, and R is hydrogen or a C₁-C₆ straight and branched chain alkyl group. Examples include ethylene glycol, propylene glycol, triethylene glycol, polyethylene glycol, polypropylene glycol, methoxy-terminated polyethylene glycol, resins derivatized with polyethylene glycol, and resins derivatized with methoxy-terminated polyethylene glycol. Other exemplary groups are set forth in Ostuni et al., Langmuir Vol. 17, pp. 5605-5620, 1991, the disclosure of which is incorporated by reference herein. Ostuni et al. also describes tests for determining nonspecific adsorption of biomolecules.

In one embodiment, the present invention relates to another treating agent(s) that can be used to attach an organic group to the granule and/or carbonaceous portion of the granule. This treating agent has a passivating group that terminates with a structure having or including the formula H₂N—Ar—[(CH₂)ₙO]ₘ(CH₂)ₙOR, wherein, as above, n is an integer ranging from 1-6, m is an integer ranging from 0-100, and R is hydrogen or a C₁-C₆ straight and branched chain alkyl group. Ar is the same as in the above formulas. In lieu of the —NH₂ ending, the terminal groups can be used. Generally, for the treating agents described herein and throughout, in the preferred reaction, the —NH₂ will be removed and the open bond on the —Ar will preferably attach onto the granule and/or carbonaceous portion of the granule.

In one embodiment, the surface of the granule can have both functional groups and passivating groups attached, such as patterned with a combination of functional groups and passivating groups.

Other exemplary organic groups that may be attached to the granules are organic groups substituted with an ionic or an ionizable group as a functional group. The ionic group may be an anionic group or a cationic group and the ionizable group may form an anion or a cation. Examples of organic groups are described in U.S. patent application Ser. No. 09/654,182 and its continuation-in-part U.S. patent application Ser. No. 09/945,340, filed Aug. 31, 2001, both disclosures being incorporated by reference herein.

A combination of different organic groups is also possible. In one embodiment, more than one type of organic group can be attached to the same granule. In another embodiment, a combination of granules is used, wherein some of the granules have been modified with at least one organic group and another portion of the granules has been modified with at least one different organic group. Varying degrees of surface modification are also possible, such as low or high percent modification of the surface area. Also, mixtures of modified carbonaceous granules and unmodified carbonaceous granules can be used.

Other examples of tailoring the organic group for the separation of specific biomolecules is set forth in Garcia et al., “Bioseparation Process Science,” Blackwell Science (1999), incorporated herein in its entirety by reference (hereinafter “Garcia et al.”). For example, heparin is used in the separation of lipoproteins. Accordingly, heparin can be attached onto carbonaceous material in order to accomplish the desired separation. Similarly, when cationic exchange processes are needed, a sulfonic acid, for instance, can be attached on a carbonaceous material and when anionic exchanges are needed, a quaternary amine can be attached onto the carbonaceous material. Thus, with the present invention, and the knowledge possessed by one skilled in the art, separation techniques can be conducted using modified carbonaceous material to achieve the selectivity desired. Thus, the present invention provides a carbonaceous material that can have one or more of the following properties, such as resistance to corrosion, swelling, and/or extreme temperatures and pressures, and the desired selectivity.

In one embodiment, the composition comprises at least one organic group attached to the granule comprising an aromatic group, such as a phenyl or naphthyl group, where the aromatic group has substituents such as sulfonic acid, carboxylic acid, or quaternary ammonium or salts thereof. In one embodiment, the at least one organic group comprises an aromatic group bonded to a polyethylene glycol spacer group linking it to the sulfonic acid, carboxylic acid, or quaternary ammonium or salts thereof. In one embodiment, an aromatic group has a cyclic, or fused cyclic structure that can be substituted (with, e.g., alkyls, aryls, halo) or unsubstituted. Examples include substituted and unsubstituted phenyl and naphthyl. Such compositions can be used as polymeric ion exchange resins. These types of carbonaceous granules of the present invention can have one or more of the following properties as compared to conventional polymeric ion exchangers:

a) higher temperature stability;

b) greater resistance to swelling; and

c) greater mechanical strength without adversely affecting uptake kinetics.

Compositions and Methods of Making

In one embodiment, to facilitate homogenization of the carbonaceous particles with the synthetic resin, pitch, or both, the components can be dispersed in a suitable solvent. In one embodiment, the solvent can be aqueous-based. In one embodiment, the solvent can be non-aqueous based or solvent based. Exemplary solvents that can be used include, but are not limited to, water, alcohols such as methanol, ethanol, propanol, or the like, organic solvents having an aromatic group such as benzene, toluene, or the like, and general organic solvents such as acetone, methylethylketone, or the like. The solvent can be used in an amount, for example, ranging from about 70 to about 400 parts by weight per 100 parts by weight of the combined carbonaceous particles and synthetic resin/pitch component.

In one embodiment, the solvent is water where, for example, water-compatible synthetic resins are used, for ease of handling and processing.

Carbonaceous particles having organic groups attached thereto can in and of themselves be used as readily dispersible carbonaceous particles, even in the absence of a surfactant.

In one embodiment, the composition can be prepared by a process comprising mixing about 100 parts by weight of carbonaceous particles with: from about 10 to about 500 parts by weight of at least one of a synthetic resin that can be carbonized by heating, and a pitch; and an organic or aqueous solvent. In one embodiment, from about 40 to about 250 parts by weight synthetic resin and/or pitch component are used per 100 parts by weight carbonaceous particles. The mixture can be formed by any manner used to combine the components. The mixture can then be granulated to form granules. The granulation can be accomplished by a wet (emulsion) granulation technique or by a spray drying granulation technique. Any of the granulation techniques described in U.S. Pat. No. 5,270,280 can be used. The granules are then subjected to conditions sufficient to carbonize the synthetic resin and/or pitch component and to evaporate the solvent. After carbonizing the granules, they can be further modified by attaching organic groups to the granules.

The granulating method may be a spray drying granulation method, a submerged granulating method (an emulsion granulating method). In one embodiment, the granules are spherical and any other suitable granulating method can be used. In one embodiment, granules are obtained from spraying a liquid mixture at an elevated temperature and evaporating, if present, the dispersing agent (e.g., surfactant) and solvent. In one embodiment, a submerged granulating method is used where a liquid mixture is added to a heated agent that is not miscible with the liquid mixture. The contact results in the formation of spheres of the liquid mixture.

Carbonization may be performed by a heat-treatment using any temperature sufficient for carbonization. In one embodiment, the heat-treatment occurs in an inert gas atmosphere at from about 400° C. to less than 800° C., for example, at a temperature of from about 400° C. to about 700° C., or 400° C. to 790° C. In another embodiment, the carbonization temperature to which the granulated carbonaceous particle-containing material is heated ranges from about 400° C. to about 600° C. Depending upon the particular synthetic resin and pitch components used, the conditions for carbonization can vary. In one embodiment, the conditions for carbonization are sufficient to carbonize the synthetic resin and/or pitch without compromising the yield and strength of the packing material. In one embodiment, heat-treatment occurs under a pressure of from about 1 to about 8 kgf/cmG though other pressures can be used.

In one embodiment, the present invention relates to a composition comprising carbonaceous particles and at least one binder that can be carbonizable. The composition can be prepared by mixing the carbonaceous particles with at least one binder and a solvent selected from an aqueous solvent or nonaqueous solvent. The mixture can then be granulated to form granules and then the granules are heated at a temperature below the temperature to carbonize the binder that is present. The granules can be heated at a temperature of from about 150° C. to about 250° C. In this process, the uncarbonized particles that are formed contain a cured/crosslinked polymer binder which is present on the granules and are useful in such applications as adsorption and chromatography.

Applications

The compositions described herein can be used as adsorbents or in separations ranging from water treatment to metals separation/recovery, ion exchange, catalysis, and the like. An additional advantage of an adsorbent possessing exchangeable groups as described above is that it confers on the granules the ability to be further surface modified using ion exchange procedures.

The granules of the present invention can be used in a number of applications, for example, as a stationary phase for chromatographic separations. Typically, a chromatographic system contains a mobile phase, a stationary phase, a pumping system, and a detector. Generally, the stationary phase contains insoluble particles which can be spherical and/or can range in size from about 15 μm to about 200 μm, such as a size ranging from about 15 μm to about 150 μm, from about 15 μm to about 100 μm, or from about 30 μm to about 100 μm. In certain embodiments, the granules have a size distribution of a full width at half maximum of about 10% to about 50%, about 10% to about 30%, or about 10% to about 20% of the mean. This size distribution may minimize the pressure drop through stationary phase.

The choice of these particles depends on the physical, chemical, and/or biological interactions that need to be exploited by the separation. Conventional stationary phases, such as silica, agarose, polystyrene-divinylbenzene, polyacrylamide, dextrin, hydroxyapatite, cross-linked polysaccharides, and polymethacrylates are functionalized with certain groups in order to accomplish the selective separation of particular chemical compounds from a mixture. The precise functional groups that accomplish this desired specification are set forth, for instance, in Garcia et al.

Another form of separation is electrophoresis which uses an applied electric field to produce directed movement of charged molecules. The process is similar to chromatographic methods in that a fixed barrier phase or stationary phase is used to facilitate separation. In the present invention, electrophoresis can be accomplished by using a stationary phase which contains the carbonaceous materials of the present invention.

Similarly, magnetic separations, such as magnetic bioseparations, can be accomplished using the carbonaceous materials of the present invention as the stationary phase.

In addition, membrane separations, such as reverse osmosis, can be accomplished by forming the membrane such that it contains carbonaceous materials. The membrane can be formed by dispersing the carbonaceous material in a polymer and casting the polymer mixture to form a membrane.

Generally, any separation technique which involves the use of a stationary phase can be improved by the present invention. The stationary phase can be or can contain the carbonaceous granules of the present invention. Upon knowing the desired chemical compound or species to be separated, the carbonaceous granules can be tailored to be selective to the targeted chemical species by attaching an organic group or organic groups onto the carbonaceous granules to suit the separation needed. Since many functional groups are known to cause selectivity in separations, these groups can be attached onto the carbonaceous granules to form the modified carbonaceous granules of the present invention and achieve the desired selectivity for separation processes.

In one embodiment, an adsorbent composition of the present invention contains modified carbonaceous granules capable of adsorbing an adsorbate wherein at least one organic group is attached to the carbonaceous granules.

The granules of the present invention can be used as a packing material or stationary phase material for chromatography. For example, a chromatographic column, such as a liquid chromatographic column, is packed with at least the packing material of the present invention. Then, a sample containing two or more components to be separated is passed, flowed, or otherwise forced through the packed column. Due to the independent affinities of the sample components, and the retention properties of the packing material with respect to the individual sample components, chemical separation of the components is achieved as the sample passes through the packed column. The packing material is also useful in gas chromatographic, high performance liquid chromatographic, solid phase extraction, and other chromatographic separation techniques.

The present invention will be further clarified by the following examples, which are intended to be purely exemplary of the present invention.

### EXAMPLE 1

Granule Formation Process

This Example describes the method for preparing the granules. The granules are formed using spray drying of a commercially available CAB-O-JET® 300 carbon-black dispersion mixed with a Dynachem Phenalloy® 2175 phenolic resin (carbonizing substance) using a rotary atomizer. The carbon-black dispersion contains approximately 15% by weight carbon black surface modified with benzoic acid groups. The carbon black has an aggregate/granule size of <1 μm, and a particle size of 18 nm. Two resin contents, with varying ratio of resin to carbon black, were used for the spray drying feed.

Granules A

5.3 liters of CAB-O-JET 300 dispersion were mixed with 262.5 gm of the Phenalloy 2175 resin. This suspension was fed into an atomizer at a flow rate of 115 mL/min. The dried product was sieved to remove granules with diameters greater than 125 μm.

Granules B

5.3 liters of CAB-O-JET 300 dispersion were mixed with 450 gm of the Phenalloy 2175 resin. This suspension was fed into an atomizer at a flow rate of 170 mL/min. The dried product was sieved to remove granules with diameters greater than 125 μm.

Granules A and B were resin cured in a tube furnace under an inert nitrogen atmosphere for 4 hours at 180° C. They were further processed by carbonization of the resin in a tube furnace at 700° C. for 2 hours under an argon atmosphere. The resulting granules were wet sieved on a 325 mesh screen in isopropanol, the top cut being the product. The granules were air dried, then oven dried at 75° C. overnight.

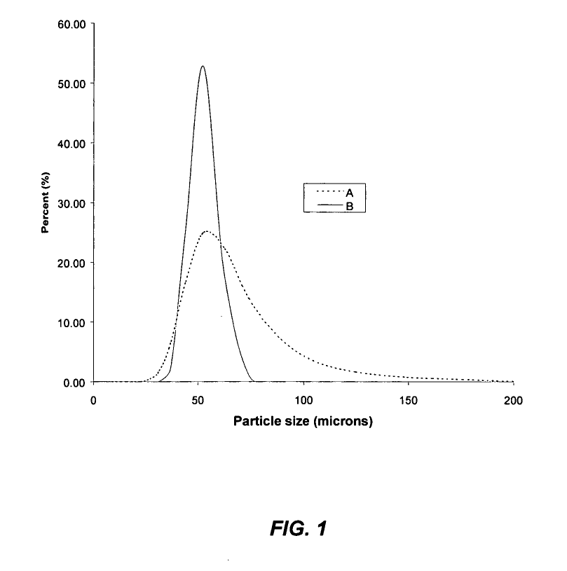

The size distributions for the resin granules A and B after sieving are shown in FIG. 1. The size distribution is determined by Microtrak.

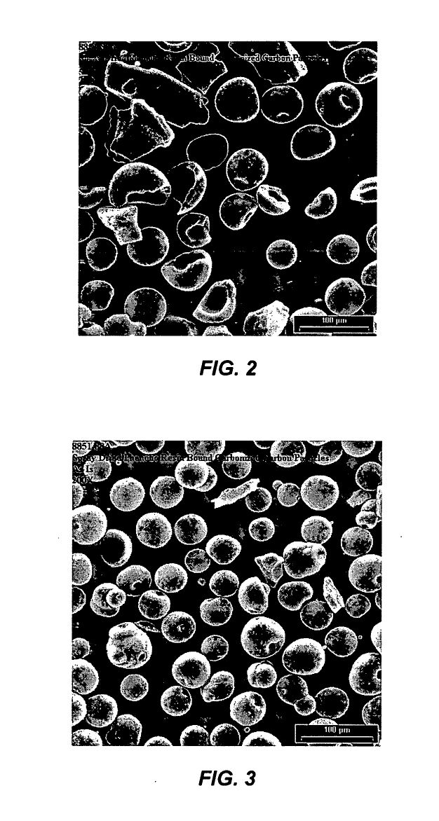

FIG. 2 is an SEM image of granules A after spray drying with the phenolic resin, shown at 200× magnification. FIG. 3 is an SEM of granules B after spray drying with the phenolic resin, shown at 200× magnification.

Granules C

BP-130 particles were suspended in a 5 wt % Triton-X-100 surfactant, and 5 wt % of a phenolic resin, Dynachem 7700 was added. This suspension was fed into a rotary atomizer and spray dried. The mean particle size measured (using a Hariba particle size analyzer) in the chamber fraction was 130 μm.

### EXAMPLE 2

This example describes the synthesis of three treating agents 4-{2-[2-(2-Diethylamino-ethoxy)-ethoxy]-ethoxy}-phenylamine (DEAE TEG aniline), 4-aminophenoxy-triethylene glycol monomethyl ether and tetra -Carboxyl Tri(ethyleneglycol) aniline. They provide anion exchange functionality, surface passivation and cation exchange functionality respectively.

### Synthesis of DEA TEG Aniline

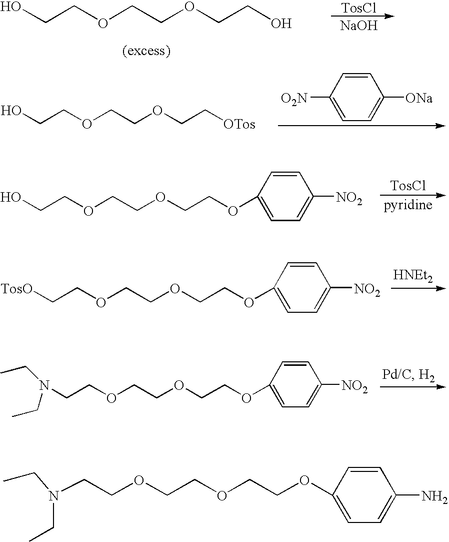 Step 1: Synthesis of TEG Tosylate

Sodium hydroxide (approximately 1 mol eq.) was dissolved in water (1:10 weight % concentration). Tri(ethylene glycol) (˜1 mol eq.) was dissolved in THF (3:10 weight % concentration). These two solutions were mixed together in a 1000 ml Erlenmeyer flask, which was in a large crystallization dish filled with an ice/water bath.

A solution of p-toluenesulfonyl chloride (˜0.33 mol eq.) in THF (3:10 weight % concentration) at 0° C. was added dropwise into the flask. After the addition was complete, the flask was covered and was taken from the ice bath and warmed slowly to room temperature. The mixture was allowed to react overnight. The reaction mixture was tested by TLC to track the progress.

When the reaction was complete. The contents of the flask were poured into a 10% HCl (excess) and ice bath. The organic part was extracted with toluene (200 ml×3) in a 2000 ml separatory funnel. The toluene layer was washed with two volumes of water, one of saturated sodium bicarbonate and a third of water. Then it was dried over sodium sulfate in a 1000 ml Erlenmeyer flask. The sodium sulfate was filtered out as the solution was transferred to a 1000 ml round-bottom flask. The toluene was evaporated off by rotary evaporation and the product was used directly in the next step. The crude yield of this product was 60-70%.

Step Two: Coupling of Nitrophenol Sodium Salt with TEG OToS

Under nitrogen the tosylate was treated with p-nitrophenol sodium salt (˜1.1 mol eq.) in acetonitrile (25 ml of solvent per gram of nitrophenol sodium salt) at reflux. The vapor level in the condenser should not rise beyond the first bulb in the condenser to ensure adequate refluxing of the acetonitrile. This reaction was tracked by TLC, and completed in four to five hours. The reaction mixture changed from a reddish yellow to a bright yellow. When finished, the solvent was evaporated off with a rotary evaporator and the residue was dissolved in 300 ml dichloromethane. The organic layer was washed in a 1000 ml separatory funnel with 200 ml each 5% HCl, water, saturated sodium hydrogen carbonate, and water. It was then dried over sodium sulfate in a 500 ml Erlenmeyer flask. The sodium sulfate was filtered out during the transfer to a 500 ml round-bottom flask. The solvent was evaporated off by rotary evaporation. If the crude product has lots of impurities, it can be purified in the automated flash chromatography. If not, the product should be purified after the next step to save on the number of columns used. The yield for this reaction was 70-75%.

Step Three: Synthesis of Nitrophenyl TEG OToS

In a 500 ml Erlenmeyer flask the product from the previous reaction was dissolved in pyridine (10 ml for every gram of nitrophenyl TEG) at 0° C. p-Toluenesulfonyl chloride (˜1.0 eq.) was slowly dissolved into the mixture. When the tosyl chloride was completely dissolved, the flask was removed from the ice bath and warmed to room temperature. This reaction can take three to four hours.

When finished, the reaction mixture was transferred into a 37% HCl/ice bath (HCl was 1.5 times (ml) the amount of pyridine added), and heat was produced. When the mixture had cooled to room temperature, the product was extracted with ethyl acetate in a 1000 ml separatory funnel. The organic layer was washed twice with water, once with sodium bicarbonate, and again with water. It was dried over sodium sulfate in a 500 ml Erlenmeyer flask. The sodium sulfate was filtered out during the transfer to a 500 ml round bottomed flask. The solvent was removed by rotary evaporation. The product was then purified using the automated flash chromatography. The yield for this reaction was 50-60%.

Step Four: Coupling Nitrophenyl TEG OToS with Diethylamine

The product from the previous reaction was dissolved in acetonitrile (200 ml) in a 500 ml round-bottom flask. Diethylamine (˜50mol eq.) was then added while stirring. A condenser was attached to the flask. The contents of the flask were brought to reflux. The condenser was affixed with a septum cap with a syringe needle inserted through to facilitate regulated air pressure, but to stop diethylamine from evaporating out. This reaction took approximately 48 hours, and can be done overnight after taking extra precautions over the integrity of the glassware and double checking all the water circulation hoses. The diethylamine had an evaporation point close to room temperature and therefore it may be necessary to add more. TLC (alumina plates are needed for this) determines the end of the reaction, which takes two to three days.

The solvent was removed by rotary evaporation and the residue was dissolved in ethyl acetate. A solid precipitated out and was removed by suction filtration through a small Buchner funnel. This solid was tosylate salt. The ethyl acetate was removed in vacuo. The product was purified using the automated flash chromatography and Alumina columns. The yield for this product was 80-90%,

Step Five: Hydrogenation of Nitrophenyl TEG DEA

The product from the previous reaction was dissolved in ethanol and was transferred to a 500 ml hydrogenation bottle. 0.3mol percent of Pd/C (palladium on activated carbon) was added to the bottle and the bottle was hooked up to the hydrogenation apparatus. The machine was stopped when no more pressure was being lost from the bottle.

The Pd/C was removed by suction filtration. The solvent was removed under vacuum both rotary evaporation and house vacuum and the product was used directly in the treatment. The yield for this step was 90-100%.

### Synthesis of 4-aminophenoxy-triethylene glycol monomethyl ether

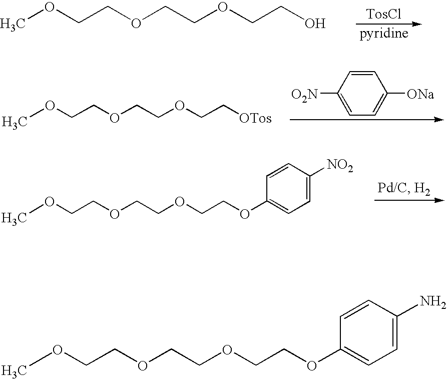 Step 1: Synthesis of TEG mME Tosylate

In a 500 ml Erlenmeyer flask, the tri(ethylene glycol) monomethyl ether (˜1 mol eq. up to 0.5 moles) was dissolved in pyridine (10 ml for every gram of TEG mME) at 0° C. p-Toluenesulfonyl chloride (˜1.0 eq. up to 0.5 moles) was slowly dissolved into the mixture. When the tosyl chloride was completely dissolved, the flask was removed from the ice bath and warmed to room temperature. This reaction took three to four hours, so track the reaction was tracked by TLC.

When finished, the reaction mixture was transferred into a 37% HCl/ice bath (HCl was 1.5 times (ml) the amount of pyridine added), heat was produced (more ice was added to cool the mixture). When the mixture cooled, the product was extracted with toluene in a 1000 ml separatory funnel. The organic layer was washed twice with water, once with sodium bicarbonate, and again with water. It was dried over sodium sulfate in a 500 ml Erlenmeyer flask. The sodium sulfate was filtered out during the transfer to a 500 ml round bottomed flask. The solvent was removed by rotary evaporation.

Step Two: Coupling of Nitrophenol Sodium Salt with TEG mME OToS

The tosylate was dissolved in acetonitrile (25 ml of solvent per gram of nitrophenol sodium salt). Under nitrogen the tosylate was treated with p-nitrophenol sodium salt (˜1.1 mol eq. up to 0.18 moles) at reflux. The vapor level in the condenser did not rise beyond the first bulb in the condenser to ensure adequate refluxing of the acetonitrile. This reaction was tracked by TLC, and was completed in four to five hours. The reaction mixture changed from a reddish yellow to a bright yellow. When finished, the solvent was evaporated off with a rotary evaporator and the residue was dissolved in 300 ml dichloromethane. The yellow salt was removed by vacuum filtration. The salt was dissolved is water and was then extracted 2×100 ml dichloromethane. The two dichloromethane portions were added together.

The organic layer was washed in a 1000 ml separatory funnel with 200 ml each 5% HCl, 2× water, saturated sodium hydrogen carbonate, and water. It was then dried over sodium sulfate in a 500 ml Erlenmeyer flask. The sodium sulfate was filtered out during the transfer to a 500 ml round-bottom flask. The solvent was evaporated off by rotary evaporation.

Step Three: Hydrogenation of Nitrophenyl TEG mME

The product from the previous reaction was dissolved in ethanol and was transferred to a 500 ml hydrogenation bottle. 0.3 mol percent of Pd/C (palladium on activated carbon) was added to the bottle and the bottle was hooked up to the hydrogenation apparatus. The machine was stopped when no more pressure was being lost from the bottle.

The Pd/C was removed by suction. The solvent was removed under vacuum both rotary evaporation and house vacuum and the product was used directly in the treatment.

### Synthesis of tetra-Carboxyl Tri(ethyleneglycol) aniline

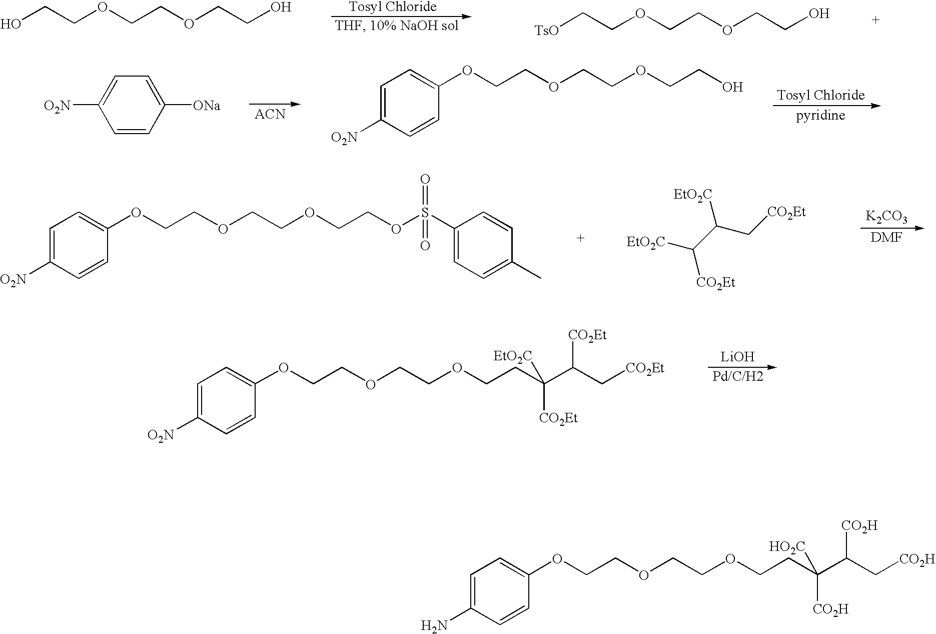

### Steps 1-3: Discussed in the DEA TEG Aniline Procedure Above

Step Four: Coupling of Nitrophenyl TEG Tosylate and 1,2,3,5-tetraethylester Pentane

In a 500 ml Erlenmeyer flask, 1,1,2,3-propanetetracarboxylic acid tetraethyl ester (˜1.0 mol. eq. up to 0.167) and potassium carbonate (˜1.0 mol. eq. up to 0.167) were mixed in 200 ml of dry DMF at room temperature for 20 mins. The product from the previous reaction in DMF (small volume) was added into the mixture. The mixture was stirred at room temperature overnight. On the second day, TLC was performed to check the progress of the reaction. Since the reaction was slow the mixture was warmed to 60-70° C. and the stirring was continued for several hours until all the materials were converted.

The DMF suspension was cooled down to room temperature and 200 ml of water was added. The product was then extracted with ethyl acetate (3×300 ml). The ethyl acetate was washed 3×200 ml water, 1×200 ml 5% hydrochloric acid, 2×200 ml water, 1×200 ml sodium bicarbonate and then 1×200 ml water. The ethyl acetate layer was dried over sodium sulfate. The ethyl acetate was removed by rotary evaporation and the product was purified using the automated flash chromatography with silica columns. The yield was ˜10%.

Step Five: Hydrolysis of Nitrophenyl TEG Tetraethylester

Lithium hydroxide (˜6mol eq. up to 1.002 mol) was dissolved in water (1 ml of water for each 0.6 grams of LiOH). The product from the previous reaction was mixed with lithium hydroxide solution and transferred to a 500 ml Erlenmeyer flask. This mixture was mixed for 24 hours at room temperature and checked by TLC to insure that the product converted. A NMR was also used to confirm conversion.

Once the TLC and NMR showed total conversion, the mixture was acidified with an excess amount of dilute hydrochloric acid (ice bath was used for the quenching since heat was generated.) The solution was extracted with ethyl acetate (3×300) and the acetate layer was dried over sodium sulfate and evaporated.

Step Six: Hydrogenation of Nitrophenyl TEG Tetracarboxylate

The product from the previous reaction was dissolved in 300 ml of THF 0.3 mol percent of Pd/C (palladium on activated carbon) was added to the bottle and the bottle was hooked up to the hydrogenation apparatus. The machine was stopped when no more pressure was being lost from the bottle.

The Pd/C was removed by suction. The solvent was removed under vacuum both rotary evaporation and house vacuum and the product was used directly in the treatment.

### EXAMPLE 3

This Example describes the surface treatment of the granules.

The granules of Example 1 were surface treated with treating agent (a) 4-Amino-benzoic acid 2-(2-methoxy-ethoxy)-ethyl ester (“aminobenzoate TEG”), which serves to passivate the carbon black surface towards any non-specific binding; and treating agent (b) 4-{2-[2-(2-Diethylamino-ethoxy)-ethoxy]-ethoxy}-phenylamine (“DEAE TEG aniline”), which imparts anion exchange functionality to the carbon surface, and has an intermediate triethylene glycol group to also provide surface passivation. A second treating agent that provides surface passivation is (c) aminophenoxy TEG monomethylether (TEG-mME). The ether group is not hydrolysable, and is expected to be more stable to high pH cleaning buffers. Synthesis procedures for the

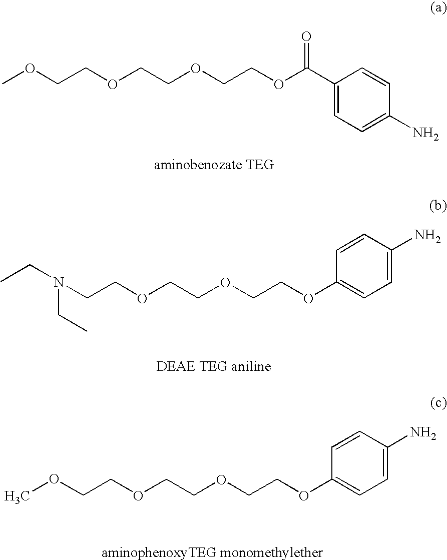

Ethanol, DEAE TEG aniline, and 37% hydrochloric acid were mixed together and heated to 40° C. or until the treating agent dissolved. The amount of treating agent used was calculated from the available surface area of the granules (˜100 m2/gm) and the target treatment level, in this case 5 μmoles/m2. The carbonized granules were added slowly and mixed well while heating slowly to 60° C. When the temperature reaches 60° C., water was added. Once the temperature rises again to 60° C. sodium nitrite was slowly added drop wise over approximately 1 minute. The reaction was monitored for 2 hours at 60° C., mixing thoroughly. After 2 hours the granules were vacuum filtered and washed with ethanol. The granules were then extracted to remove any unattached treating agent as well as any polyaromatic hydrocarbons. Each set of granules was treated twice with DEAE TEG aniline. In order to assure as complete a degree of surface passivation as possible, this was followed by two treatments using aminobenzoate TEG, using the same procedure. In another embodiment, the particles were treated once with TEG-mME, four times by DEAE-TEG aniline followed by once with TEG-mME.

In order to characterize the ability of the aminobenzoate TEG to block any non-specific binding of virus, a set of granules was subjected to four treatments using this treating agent.

### EXAMPLE 4

This Example describes the chromatographic separation.

The granules were slurried in a solvent containing 25% IPA, 75% water (v/v), and pipetted into a column (0.66 cm×10 cm−OmniFit®) with a 25 μm polyethylene frit at the bottom. Excess liquid was removed using a manual plunger. The bed volume was approximately 4 mL. The column was then conditioned using a 1 M NaCl buffer. A buffered solution containing adenovirus (10¹² virus particles/ml in 0.1 mM NaCl and 20 mM Tris, pH 7.5) was used as the feed. One bed volume of solution was passed through the columns at a flow rate of 1 mL/min. The column was then washed with 5 bed volumes of 0.1M NaCl in 50 mM Tris (at 1 mL/min). The fraction collected at the bottom of the column during this stage is called flow-through, and contains all unbound species. This was followed by elution with 5 bed volumes of 1 M NaCl in 20 mM Tris solution (at 1 mL/min). The eluate contained the ionically bound species. The feed, the flow-through as well as the eluate were examined using IEX-HPLC to quantify the virus titer in each of these streams and the yield in the flow-through and eluate streams determined. In addition, a break-through experiment was conducted to determine viral binding capacity of the column. These results are summarized in Tables I and II.

TABLE I
Yield and binding capacity for granules A

| | | Binding capacity (virus |
|---|---|---|
| Particle type/stream | Yield | particles/ml of packed bed) |
| Untreated/flow through | 70% | |
| Untreated/eluate | 0% | |
| Aminobenzoate-TEG/flow- | 105% | |
| through | | |
| Aminobenzoate-TEG/eluate | 0% | 0% |
| Aminophenyl-TEG - DEAE/ | 5% | |
| flow-through | | |
| Aminophenyl-TEG - DEAE/ | 84% | 9.01 × 10¹¹ |
| eluate | | |

TABLE II
Yield and binding capacity for granules B

| | | Binding capacity (virus |
|---|---|---|
| Particle type/stream | Yield | particles/ml of packed bed) |
| Untreated/flow through | 77% | |
| Untreated/eluate | 0% | |
| Aminobenzoate-TEG/flow- | 99% | |
| through | | |
| Aminobenzoate-TEG/eluate | 0% | 0% |
| Aminophenyl-TEG - DEAE/ | 0% | |
| flow-through | | |
| Aminophenyl-TEG - DEAE/ | 33% | 3.99 × 10¹¹ |
| eluate | | |

For granules A, the 70% yield in the flow-through represents the virus remaining in the interstitial spaces after one bed volume of feed flow is stopped. Along with the fact that no virus is recovered in the eluate, this implies 30% of the virus is bound non-specifically to the carbon granules. For the aminobenzoate TEG treated granules, all the virus comes out in the flow-through fraction, implying complete surface passivation by this treatment. Surface passivation to prevent non-specific binding helps to improve the yield for any chromatographic media being used for purification of biological therapeutics, since any non-specifically bound material is difficult to recover. For the aminophenyl-TEG-DEAE treated granules, low recovery in the flow-through fraction, followed by 84% recovery in the eluate implies that a large fraction of the virus in the feed was bound ionically to the granules. The capacity of the aminophenyl-TEG-DEAE granules was also higher than that of current commercially available media (for example, twice the capacity of Amersham Source 30Q) being used for viral purification.

For granules A, 23% of the virus is bound non-specifically to the carbon granules. For the aminobenzoate TEG treated granules, all the virus came out in the flow-through fraction, implying complete surface passivation by this treatment. For the aminophenyl-TEG-DEAE treated granules, the low recovery in the flow-through fraction was followed by 33% recovery in the eluate. The capacity of the aminophenyl-TEG-DEAE granules is comparable to that of current commercially available media (for example, Amersham Source 30Q) being used for viral purification.

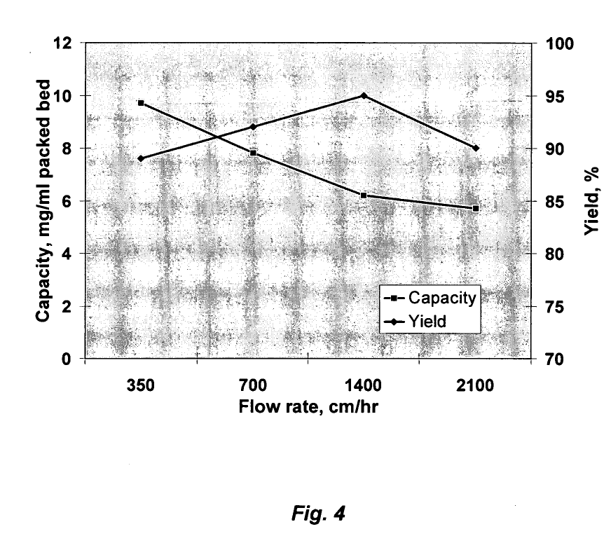

Yield and binding capacity measurements were conducted using the TEG-mME/DEAE-TEG aniline/TEG-mME particles, using 5 wt % BSA solution as the feed. The feed was passed through the column until breakthrough. A buffer containing 50 mM tris (hydroxymethyl) aminomethane (tris) was used as the flow through solution. The flow is continued until no BSA is detected, indicating the removal of all the unbound protein. This is followed by an elution buffer that contains 0.5M NaCl along with the 50 mM tris. The mass of BSA leaving the column during this stage is ionically bound. The yield is defined as the mass of ionically bound BSA divided by the total mass of BSA bound to the particles in the column. The ionic binding capacity is reported as the mass of ionically bound BSA divided by the volume of the packed bed. These values are evaluated as a function of linear flow rate (volumetric flow rate/column cross-sectional area). FIG. 4 summarizes sample results from the test.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims and equivalents thereof.

What is claimed is:

1. A composition comprising:
granules comprising:
carbonaceous particles; and
at least one carbonized substance selected from carbonized synthetic resins and carbonized pitches; and
at least one organic group attached to the surface of the granules;
wherein the granules have a mean diameter ranging from about 15 μm to about 200 μm and a mean pore size of less than about 500 nm.

2. The composition according to claim 1, wherein the granules have a size distribution of a full width at half maximum ranging from about 10% to about 50% of the mean.

3. The composition according to claim 1, wherein the granules have a size distribution of a full width at half maximum ranging from about 10% to about 30% of the mean.

4. The composition according to claim 1, wherein the granules have a size distribution of a full width at half maximum ranging from about 10% to about 20% of the mean.

5. The composition according to claim 1, wherein the at least one organic group is a functional group for interacting with a biomolecule.

6. The composition according to claim 5, wherein the functional group comprises a group selected from:
polyethylene glycol, methoxy-terminated polyethylene glycol, resins derivatized with polyethylene glycol, or resins derivatized with methoxy-terminated polyethylene glycol;
—Ar—(CH₂)ₘ(O(CH₂)_{y})ₙNR₂ or —Ar—(CH₂)ₘ(O(CH₂)_{y})ₙN⁺R₃, wherein m and y are independently chosen from an integer ranging from zero to 6; n ranges from 1 to 30; and R is hydrogen or an alkyl group;
—Ar—C(O)(O(CH₂)_{y})ₙNR₂ or —Ar—C(O)(O(CH₂)_{y})ₙN⁺R₃, wherein y is an integer ranging from zero to 6; n ranges from 1 to 30; and R is hydrogen or an alkyl group;
—Ar—C(O)NH(CH₂)ₘ(O(CH₂)_{y})ₙNR₂ or —Ar—C(O)NH (CH₂)ₘ(O(CH₂)_{y})ₙN⁺R₃, wherein m and y are independently chosen from an integer ranging from zero to 6; n ranges from 1 to 30; and R is hydrogen or an alkyl group;
—Ar—(CH₂)ₘ(O(CH₂)_{y})ₙCOOH, wherein m and y are independently chosen from an integer ranging from zero to 6; n ranges from 1 to 30;
—Ar—(CH₂)ₘ(O(CH₂)_{y})ₙSO₃H, wherein m and y are independently chosen from an integer ranging from zero to 6; n ranges from 1 to 30;
—Ar—((CₙH₂ₙ)COOX)ₘ, wherein n ranges from 0 to 20, m ranges from 1 to 3, and X is hydrogen, a cation, a quaternary ammonium group, or an organic group capable of bonding to a carboxylate;
—Ar—((CₙH₂ₙ)OH)ₘ, wherein n ranges from 0 to 20, and m ranges from 1 to 3;
—Ar—((CₙH₂ₙ)NR₂)ₘ, wherein n ranges from 0 to 20, m ranges from 1 to 3, and R is hydrogen or an alkyl group;
—Ar—((CₙH₂ₙ)NR₃X)ₘ, wherein n ranges from 0 to 20, m ranges from 1 to 3, X is an anion, and R is hydrogen or an alkyl group;
—Ar—R wherein R is an ionic or ionizable group; or
a ligand, for binding a target;
wherein Ar is an aromatic group in each formula and each R in each formula is the same or different.

7. The composition according to claim 1, wherein the functional group is an ionic or ionizable group.

8. The composition according to claim 1, wherein the at least one organic group is a passivating group that substantially resists the adsorption of biomolecules.

9. The composition according to claim 8, wherein the passivating group terminates with a structure having the formula —[(CH₂)ₙO]ₘ(CH₂)ₙOR, wherein n is an integer ranging from 1-6, m is an integer ranging from 0-100, and R is hydrogen or a C₁-C₆ straight or branched chain alkyl group.

10. The composition according to claim 1, wherein the composition is a chromatographic material.

11. The composition according to claim 10, wherein the chromatographic material is an anion exchange chromatographic material.

12. The composition according to claim 10, wherein the chromatographic material is a cation exchange chromatographic material.

13. The composition according to claim 10, wherein the chromatographic material is an affinity chromatographic material.

14. The composition according to claim 1, wherein said carbonaceous particles are carbon black.

15. The composition according to claim 1, wherein the at least one carbonized substance is a carbonized synthetic resin.

16. The composition according to claim 15, wherein the carbonized synthetic resin is a phenol resin, furan resin, furfural resin, divinyl benzene resin, or urea resin or combinations thereof.

17. The composition according to claim 1, wherein the at least one carbonized substance is a carbonized pitch.

18. The composition according to claim 17, wherein the carbonized pitch is a toluene-soluble pitch or a benzene-soluble pitch.

19. The composition according to claim 17, wherein the carbonized pitch is a petroleum pitch, coal-tar pitch, or liquefied coal oil or combinations thereof.

20. The composition according to claim 1, wherein the granules comprise 100 parts by weight carbon black and the at least one carbonized substance in an amount ranging from about 5 to about 500 parts by weight.

21. The composition according to claim 1, wherein the composition is a chromatographic material for bioseparation.

22. The composition according to claim 1, wherein the composition is a chromatographic material for viral separation.

23. A chromatographic material for the separation of a virus, comprising:
granules comprising:
carbonaceous particles; and
at least one carbonized substance selected from carbonized synthetic resins and carbonized pitches; and
at least one organic group attached to the surface of the granules;
wherein the granules have a mean diameter ranging from about 15 μm to about 200 μm and a mean pore size of at least about five times the mean size of the virus to be separated.

24. The chromatographic separation material according to claim 23, wherein the granules have a mean pore size of at least about ten times the mean size of the virus to be separated.

25. A composition comprising:
granules comprising:
carbonaceous particles; and
at least one carbonized substance selected from carbonized synthetic resins and carbonized pitches; and
at least one organic group attached to the surface of the granules;
wherein the granules have a mean diameter ranging from about 15 μm to about 200 μm and a mean pore size of at least about 0.5 μm.

26. The composition according to claim 25, wherein the granules have a mean pore size of at least about 1 μm.

27. A method of chromatographic separation comprising:
(a) providing a chromatography column containing a composition comprising:
(i) granules comprising:
carbonaceous particles; and
at least one carbonized substance selected from carbonized synthetic resins and carbonized pitches; and
(ii) at least one organic group attached to the surface of the granules;
wherein the granules have a mean diameter ranging from about 15 μm to about 200 μm and a mean pore size of less than about 500 nm; and
(b) providing a sample containing at least one biomolecule; and
(c) passing the at least one biomolecule through the column.

28. The method according to claim 27, wherein the at least one biomolecule is a virus.

29. The method according to claim 27, wherein the at least one biomolecule is a protein.

30. A method of chromatographic separation of a virus, comprising:
(a) providing a chromatography column containing a composition comprising:
(i) granules comprising:
carbonaceous particles; and
at least one carbonized substance selected from carbonized synthetic resins and carbonized pitches; and
(ii) at least one organic group attached to the surface of the granules;
wherein the granules have a mean diameter ranging from about 15 μm to about 200 μm and a mean pore size of at least about five times the mean size of the virus to be separated; and
(b) providing a sample containing at least one biomolecule; and
(c) passing the at least one biomolecule through the column.

31. A method of chromatographic separation comprising:
(a) providing a chromatography column containing a composition comprising:
(i) granules comprising:
carbonaceous particles; and
at least one carbonized substance selected from carbonized synthetic resins and carbonized pitches; and
(ii) at least one organic group attached to the surface of the granules;
wherein the granules have a mean diameter ranging from about 15 μm to about 200 μm and a mean pore size of at least about 0.5 μm; and
(b) providing a sample containing at least one biomolecule; and
(c) passing the at least one biomolecule through the column.

32. The composition according to claim 1, wherein the granules have a mean pore size of 0.5 nm to less than about 500 nm.

33. The composition according to claim 1, wherein the granules have a pore size distribution, with pores ranging from about 50 nm to about 200 nm.

34. A treating agent comprising one of the following formulas:
H₂N—Ar—(CH₂)ₘ(O(CH₂)_{y})ₙNR₂ or H₂N—Ar—(CH₂)ₘ(O(CH₂)_{y})ₙN⁺R₃, wherein m and y are independently an integer ranging from zero to 6; n ranges from 1 to 30; and R is hydrogen or at least alkyl group;
H₂N—Ar—C(O)(O(CH₂)_{y})ₙNR₂ or H₂N—Ar—C(O)(O(CH₂)_{y})ₙN⁺R₃, wherein y is an integer ranging from zero to 6; n ranges from 1 to 30; and R is hydrogen or at least one alkyl group;
H₂N—Ar—C(O)NH(CH₂)ₘ(O(CH₂)_{y})ₙNR₂ or H₂N—Ar—C(O)NH(CH₂)ₘ(O(CH₂)_{y})ₙN⁺R₃, wherein m and y are independently an integer ranging from zero to 6; n ranges from 1 to 30; and R is hydrogen or at least one alkyl group;
H₂N—Ar—(CH₂)ₘ(O(CH₂)_{y})ₙCOOH, wherein m and y are independently an integer ranging from zero to 6; n ranges from 1 to 30;
H₂N—Ar—(CH₂)ₘ(O(CH₂)_{y})ₙSO₃H, wherein m and y are independently an integer ranging from zero to 6; n ranges from 1 to 30;
H₂N—Ar—((CₙH₂ₙ)COOX)ₘ, wherein n ranges from 0 to 20, m ranges from 1 to 3, and X is hydrogen, a cation, or an organic group capable of bonding to a carboxylate;
H₂N—Ar—((CₙH₂ₙ)OH)ₘ, wherein n ranges from 0 to 20, and m ranges from 1 to 3;
H₂N—Ar—((CₙH₂ₙ)NR₂)ₘ, wherein n ranges from 0 to 20, m ranges from 1 to 3, and R is hydrogen or at least one alkyl group;
H₂N—Ar—((CₙH₂ₙ)NR₃X)ₘ, wherein n ranges from 0 to 20, m ranges from 1 to 3, X is an anion, and R is hydrogen or at least one alkyl group; wherein Ar in each of the above formulas is at least one aromatic group and each R in each formula is the same or different.

35. A treating agent comprising a structure having or including the formula H₂N—Ar—[(CH₂)ₙO]ₘ(CH₂)ₙOR, wherein n is an integer ranging from 1-6, m is an integer ranging from 0-100, and R is hydrogen or a C₁-C₆ straight and branched chain alkyl group and Ar is at least one aromatic group.
